(19) United States
(12) Patent Application Publication
(10) Pub. No.: US 2006/0228549 A1
(43) Pub. Date: Oct. 12, 2006

(54) Polymer coated metal oxide and process for producing the same

(76) Inventors: Masaaki Kakimoto, Tokyo (JP); Mitsutoshi Jikei, Tokyo (JP); Eriko Suzuki, Tokyo (JP)

Correspondence Address: William S. Frommer;Frommer Lawrence & Haug, 745 Fifth Avenue, New York, NY, 10151, US

(21) Appl. No.: 10/545,741

(22) PCT Filed: Feb. 18, 2004
(86) PCT No.: PCT/JP04/01789

§ 371 Date: Apr. 3, 2006

(30) Foreign Application Priority Data
Feb. 18, 2003 (JP) 2003-40251

(51) Int. Cl. B32B 5/16

(52) U.S. Cl. 428/402

(57) ABSTRACT

An object of the present invention is to provide a novel polymer coated metal oxide. A polymer coated metal oxide according to the present invention is characterized in that a polymer has a siloxane skeletal structure. A polymer coated metal oxide manufacturing method according to the present invention is a method of contacting a metal oxide with a solution of a polymer having a siloxane skeletal structure. As a result, a polymer can be bonded to the surface of a metal oxide. Herein, it is preferable that a polymer should have a branching structure. Also, it is preferable that the polymer having the branching structure should be a dendritic polymer. Further, it is preferable that a metal oxide should be glass, silica gel, titanium oxide, barium titanate, indium tin oxide (ITO), aluminum oxide, nickel oxide, iron oxide and the like.

### TECHNICAL FIELD

The present invention related to a polymer coated metal oxide and a manufacturing method thereof.

### BACKGROUND ART

So far silane coupling agents have been available for surface finishing of metal oxide (Yoshioka, Hiroshi. Silane coupling agents. Nippon Setchaku Kyokaisha (1985), 21 (6), 252-60. CODEN; NSKSAZ ISSN:0001-8201, CAN103; 105586 AN 1985:505586 CAPLUS (Copyright 2003ACS) or Tadanaga, Kiyoharu; Ueyama, Kaori; Sueki, Toshitsugu; Matsuda, Atsunori; Minami, Tsutomu, Micropatterning of Inorganic-Organic Hybrid Coating Films from Various Tri-Functional Silicon Alkoxides with a Double Bond in Their Organic Components. Journal of Sol-Gel Science and Technology (2003), 26 (1-3), 431-434, CODEN; JSGTEC ISSN; 0928-0707, AN2002; 815093 CAPLUS (Copyright 2003ACS)).

On the one hand, a dendric polymer receives a remarkable attention because it has a large number of terminals with a high density unlike a normal chain polymer (Official Gazette of JP-8-510761T).

### DISCLOSURE OF THE INVENTION

In the above-mentioned conventional silane coupling agents, only one functional group can be introduced per molecule so that a problem arises, in which it is difficult to control functions with surface finishing. For this reason, it is desired that a compound can introduce a large number of functional groups at a time.

On the other hand, since the conventional dendritic polymer has poor adhesion with a metal oxide, it has never been tried to coat the metal oxide with the dendritic polymer.

It is an object of the present invention to provide a novel polymer coated metal oxide and a manufacturing method thereof.

A polymer coated metal oxide according to the present invention is such one that a polymer has a siloxane skeletal structure. Thus, the polymer can be bound on the surface of the metal oxide.

Herein, it is preferable that a polymer should have a branching structure. Also, it is preferable that the polymer that has the branching structure should be the dendritic polymer. Further, it is preferable that the polymer should be a polymerized product obtained by mixing singles of or more than two kinds of bis(dimethyl vinyl siloxy)methyl silane, tris(dimethyl vinyl siloxy)silane and bis(dimethyl allyl siloxy)methyl silane and tris(dimethyl allyl siloxane)silane or by mixing singles of or more than two kinds of bis(dimethyl siloxy)methyl vinyl silane, tris(dimethyl siloxy)vinyl silane, bis(dimethyl siloxy)methyl allyl silane and tris(dimethyl siloxy)allyl silane. Furthermore, it is preferable that a metal oxide should be a product obtained by combining singles of or more than two kinds of glass, silica gel, titanium oxide, barium titanate, indium tin oxide (ITO), aluminum oxide, nickel oxide and iron oxide.

Also, a polymer coated metal oxide manufacturing method according to the present invention is a method of contacting a metal oxide with a solution of a polymer having a siloxane skeletal structure. As a result, a polymer can be bonded to the surface of the metal oxide.

Herein, it is preferable that a polymer should have a branching structure. Also, it is preferable that the polymer that has the branching structure should be the dendritic polymer. Further, it is preferable that the polymer should be a polymerized product obtained by mixing singles of or more than two kinds of bis(dimethyl vinyl siloxy)methyl silane, tris(dimethyl vinyl siloxy) silane and bis(dimethyl allyl siloxy)methyl silane and tris(dimethyl allyl siloxane) silane or by mixing singles of or more than two kinds of bis(dimethyl siloxy)methyl vinyl silane, tris(dimethyl siloxy)vinyl silane, bis(dimethyl siloxy)methyl allyl silane and tris(dimethyl siloxy) allyl silane. Furthermore, it is preferable that a metal oxide should be a product obtained by combining singles of or more than two kinds of glass, silica gel, titanium oxide, barium titanate, indium tin oxide (ITO), aluminum oxide, nickel oxide and iron oxide.

The present invention can achieve the effects which will follow.

It is possible to provide a novel compound by using a metal oxide coated with a polymer having a siloxane skeletal structure or by contacting a metal oxide with a solution of a polymer having a silioxane skeletal structure.

### BRIEF DESCRIPTION OF DRAWINGS

FIG. 1 is an NMR spectrum of an intermediate synthesized by a reference example 1;

FIG. 2 is an NMR spectrum of a monomer synthesized by a reference example 2;

FIG. 3 is an NMR spectrum of a polymer synthesized by a reference example 3;

FIG. 4 is an infrared absorption spectrum of the polymer synthesized by the reference example 3;

FIG. 5 is a GPC chart of the polymer synthesized by the reference example 3;

FIG. 6 is an XPS spectrum of a silica gel that is not yet treated in an inventive example 1;

FIG. 7 is an XPS spectrum of silica gel particles that were already treated in the inventive example 1;

FIG. 8 is an XPS spectrum of silica gel particles that were already treated in a comparative example 1;

FIG. 9 is an XPS spectrum of a silica gel that is not yet treated in an inventive example 2;

FIG. 10 is an XPS spectrum of silica gel particles that were already treated in the inventive example 2;

FIG. 11A is an SEM photograph of the silica gel that is not yet treated in the inventive example 2;

FIG. 11B is an SEM photograph of the silica gel particles that were already treated in the inventive example 2;

FIG. 12 is an XPS spectrum of titanium oxide particles that are not yet treated in an inventive example 3;

FIG. 13 is an XPS spectrum of titanium oxide particles that were already treated in the inventive example 3;

FIG. 14A is an SEM photograph of a titanium oxide that is not yet treated in the inventive example 3;

FIG. 14B is an SEM photograph of titanium oxide particles that were already treated in the inventive example 3;

FIG. 15 is an XPS spectrum of titanium oxide particles that were already treated in a comparative example 2;

FIG. 16 is an SEM photograph of titanium oxide particles that were already treated in the comparative example 2;

FIG. 17 is an XPS spectrum of barium titanate particles that are not yet treated in an inventive example 4;

FIG. 18 is an XPS spectrum of barium titanate particles that are not yet treated in the inventive example 4;

FIG. 19 is an XPS spectrum of barium titanate particles that are not yet treated in the inventive example 4;

FIG. 20 is an XPS spectrum of barium titanate particles that are not yet treated in the inventive example 4;

FIG. 21 is an XPS spectrum of barium titanate particles that were already treated in the inventive example 4;

FIG. 22 is an XPS spectrum of barium titanate particles that were already treated in the inventive example 4;

FIG. 23 is an XPS spectrum of barium titanate particles that were already treated in the inventive example 4;

FIG. 24 is an XPS spectrum of barium titanate particles that were already treated in the inventive example 4; and

FIG. 25 is a photograph showing the state in which barium titanate particles (left-hand side test tube) that were already treated barium titanate particles (right-hand side test tube) that were not yet treated are dispersed into methyl ethyl ketone in an inventive example 6.

### BEST MODE FOR CARRYING OUT THE INVENTION

A polymer coated metal oxide and a manufacturing method thereof according to embodiments of the present invention will be described hereinafter.

First, a starting material of a polymer coated metal oxide will be described. A metal oxide and a polymer are used as starting materials.

A metal oxide will be described. A metal oxide is not limited to a particular one but it may be such one obtained by combining singles or more than two kinds of glass, silica gel, titanium oxide, barium titanate, indium tin oxide (ITO), aluminum oxide, nickel oxide and iron oxide. These elements may be properly and selectively used depending on the purposes.

Also, the shape of the metal oxide is not limited to a particular one but it may be provided by combining singles or more than two kinds of grain-like, thread-like or plate-like metal oxide.

Further, in a metal oxide, the whole of a compound need not always be an oxide. For example, in the metals of magnesium, aluminum, titanium, chromium, iron, cobalt, nickel, copper, zinc, silver and tin, a metal oxide may be a metal oxide coated film formed on the surface of a metal.

A polymer will be described. A polymer according to the present invention is not limited to a particular one insofar as it has a poly siloxane skeletal structure. Preferably, the polymer should have a branching structure. Further, the polymer that has the branching structure should be a dendritic polymer. Furthermore, an example of the dendritic polymer may be a polymerized product obtained by mixing singles of or more than two kinds of bis(dimethyl vinyl siloxy)methyl silane, tris(dimethyl vinyl siloxy) silane and bis(dimethyl allyl siloxy)methyl silane and tris(dimethyl allyl siloxane) silane or by mixing singles of or more than two kinds of bis(dimethyl siloxy)methyl vinyl silane, tris(dimethyl siloxy)vinyl silane, bis(dimethyl siloxy)methyl allyl silane and tris(dimethyl siloxy) allyl silane as shown in formulas (chemical formulas 1 to 8).

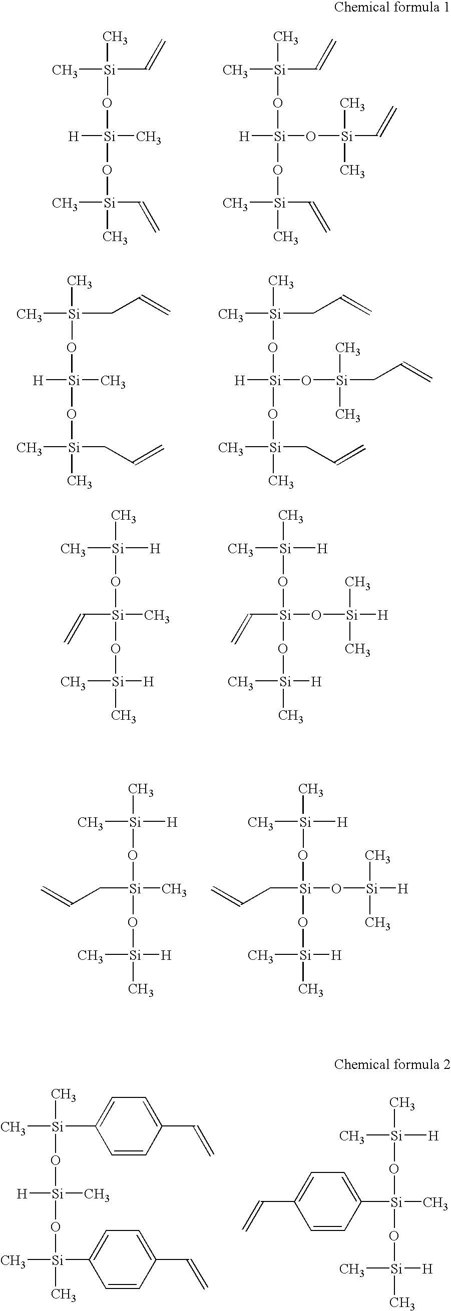

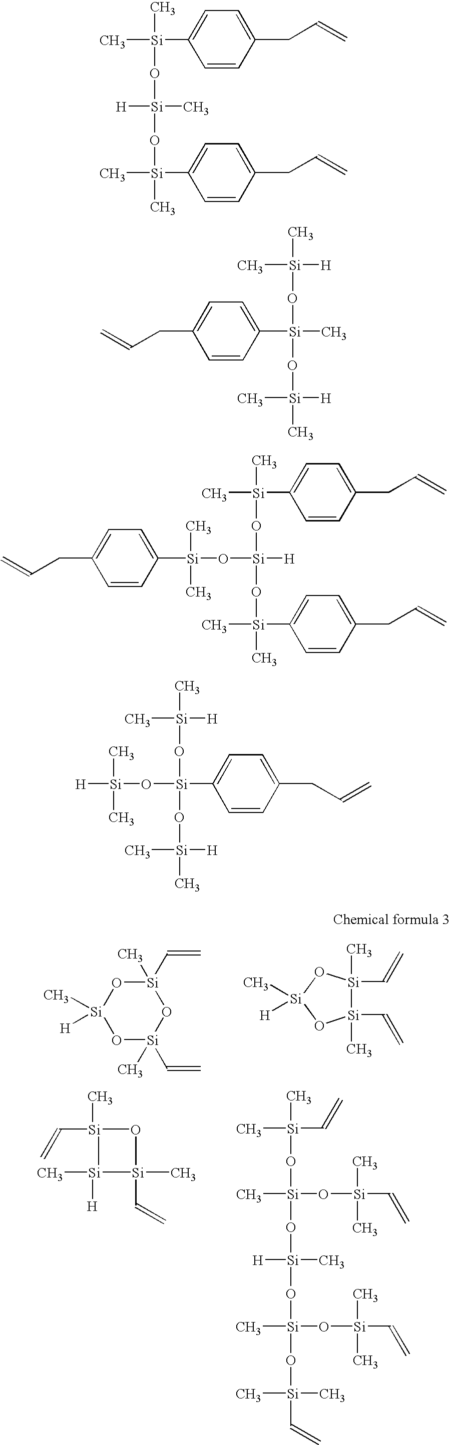

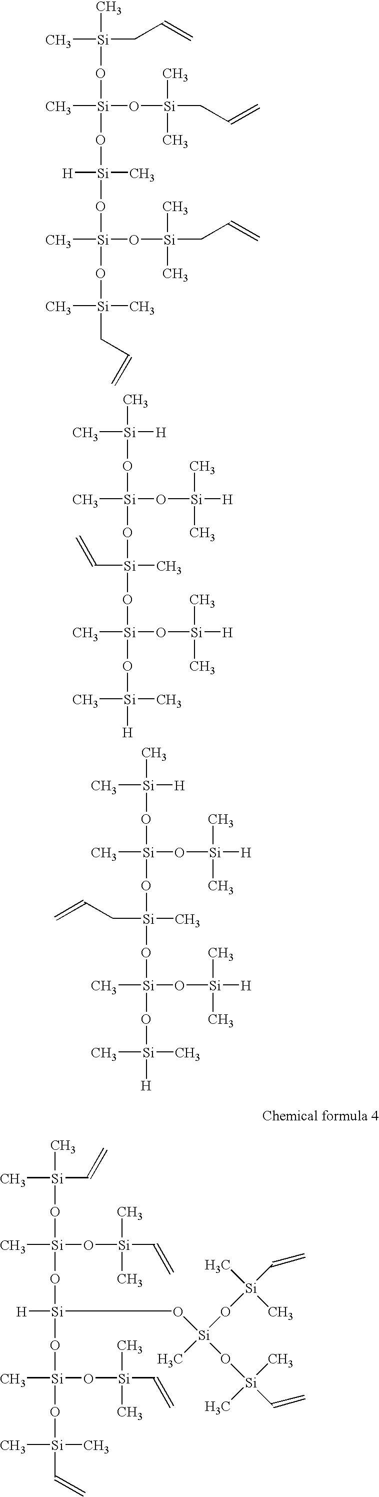

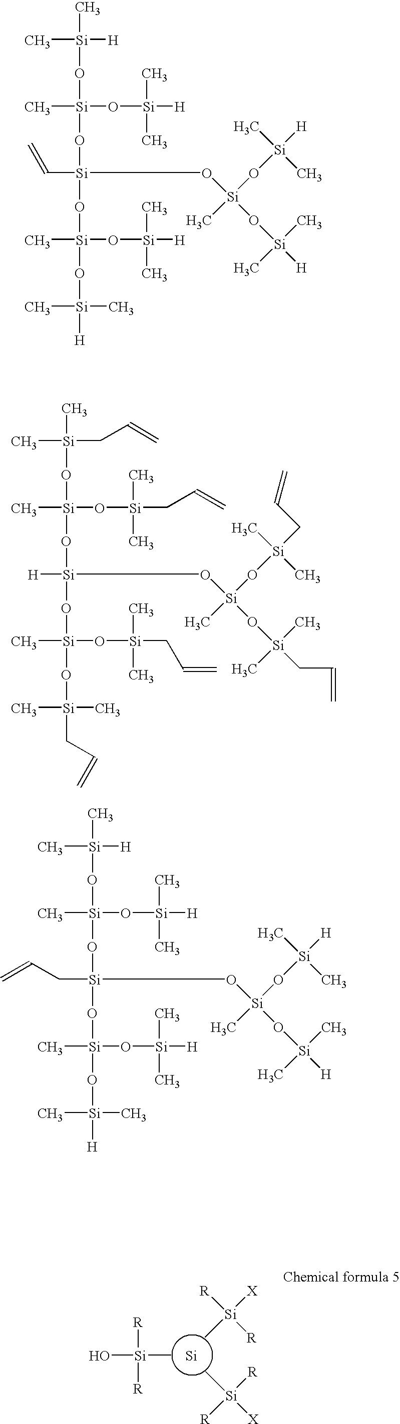

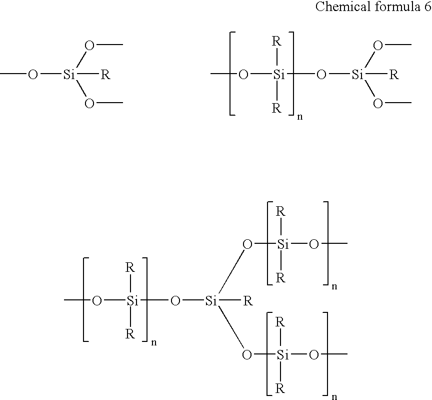

Si is one selected from the following ones.

R is the same or different hydrogen atom, methyl group, ethyl group, propyl group

n is 1 to 10 and

X is one selected from Cl and Br.

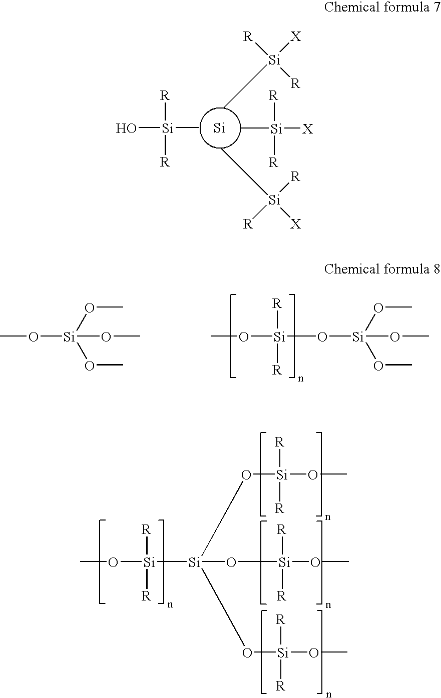

Si is one selected from the following ones.

R is the same or different hydrogen atom, methyl group, ethyl group, propyl group

n is 1 to 10 and

X is one selected from Cl and Br.

A molecular weight of a coated polymer is not limited to a particular one and it may fall within a range of from 1000 to 80000. Preferably, it should fall within a range of from 1000 to 60000 and it is more preferable that it should fall within a range of from 1000 to 45000. If the molecular weight of the polymer is less than 1000, then the molecular weight is too low so that a sufficiently large coated quantity may not be obtained even when it is coated on the metal oxide. Also, if the molecular weight is greater than 80000, then the molecular weight of the polymer is too large so that a quantity of molecule is increased, thereby resulting in a coated quantity being decreased.

The polymer according to the present invention is strongly coated on the metal oxide. The polymer may not be limited to a particular one so long as it is coated on the metal oxide. The bonding form may be a covalent bond or an ionic bond, a hydrogen bond, a hydrophobic bond or it may be such one provided by combining these bonds.

When a metal oxide is shaped like a grain, a polymer coated quantity may fall within a range of from 0.005 to 0.2 g per 1 g of a metal oxide. Preferably, it should fall within a range of from 0.007 to 0.19 g. More preferably, it should fall within a range of from 0.008 to 0.19 g. If a coated quantity is less than 0.005 g, then a coated effect may become small. Also, if it becomes greater than 0.2 g, then a function of a coated metal will be lost, which should not be preferable.

A method of manufacturing a polymer coated metal oxide will be described. A polymer coated metal oxide can be manufactured by contacting a metal oxide with a solution of a polymer having a siloxane skeletal structure.

A solvent used in that case may be such one that can dissolve or disperse a polymer and it may be obtained by combining singles or more than two kinds of acetone, hexane, toluene, methyl ethyl ketone, methyl alcohol, ethyl alcohol and water. A solvent may not be restricted to a particular one.

A reaction temperature may not be limited to a particular one so long as it can cause a polymer and a coated metal oxide to react with each other. When a polymer is heated in a solution, a reaction temperature may fall within a range of from 3 to 200° C. Preferably, it should fall within a range of from 5 to 180° C. More preferably, it should fall within a range of from 10 to 150° C.

Also, after a polymer having a siloxane skeletal structure was contacted with a metal oxide in a solution, it can be strongly bonded to the metal oxide by heating the polymer in the air or under the circumstance of a nitrogen gas. A heating temperature in this case may fall within a range of from 30 to 200° C. Preferably, it should fall within a range of from 30 to 200° C. and more preferably, it should fall within a range of from 50 to 150° C.

According to the present invention, a polymer concentration in a reaction solution may not be limited to a particular one and it may fall within a range of from 0.01 to 10 mass %. Preferably, it should fall within a range of from 0.05 to 8 mass % and more preferably, it should fall within a range of from 0.5 to 5 mass %.

A polymer coated metal oxide manufacturing method is not limited to a method in which a metal oxide is immersed into a polymer solution. In addition, the present invention can adopt other method of coating a polymer solution on a metal oxide or other method of electrodepositing a metal oxide in the electric field.

A polymer coated metal oxide will be described. A bonding state between a polymer and a metal oxide may be considered as follows. It may be estimated such that a recombination reaction occurs between a siloxane bond in the polymer skeletal structure and M-OH (M is metal) in the metal oxide to generate an M-O—Si bond.

As described above, according to the embodiments of the present invention, when the metal oxide is coated with the polymer having the siloxane skeletal structure or when the metal oxide is contacted with the solution of the polymer having the siloxane skeletal structure, the polymer can be bonded to the surface of the metal oxide. As a result, it is possible to provide a novel compound.

Since the polymer having the branching structure has many end groups unlike the normal chain polymer, various functional groups can be introduced into these end groups. Consequently, the surface of the metal oxide can be modified by various functional groups.

The present invention can be applied to a chromatography carrier, an antifouling treatment glass, a surface finishing composite filler, a surface finishing condenser, base materials for cosmetics, a hair rinsing agent, a hair treatment agent, a detergent for clothes, treatment agents for clothes and the like.

The present invention is not limited to the above-mentioned embodiments and it is needless to say that the present invention can take other various arrangements without departing from the gist of the present invention.

Inventive examples will be described concretely. However, it is needless to say that the present invention may not be limited to these inventive examples.

### REFERENCE EXAMPLE 1

Synthesis of Dimethyl Vinyl Silane

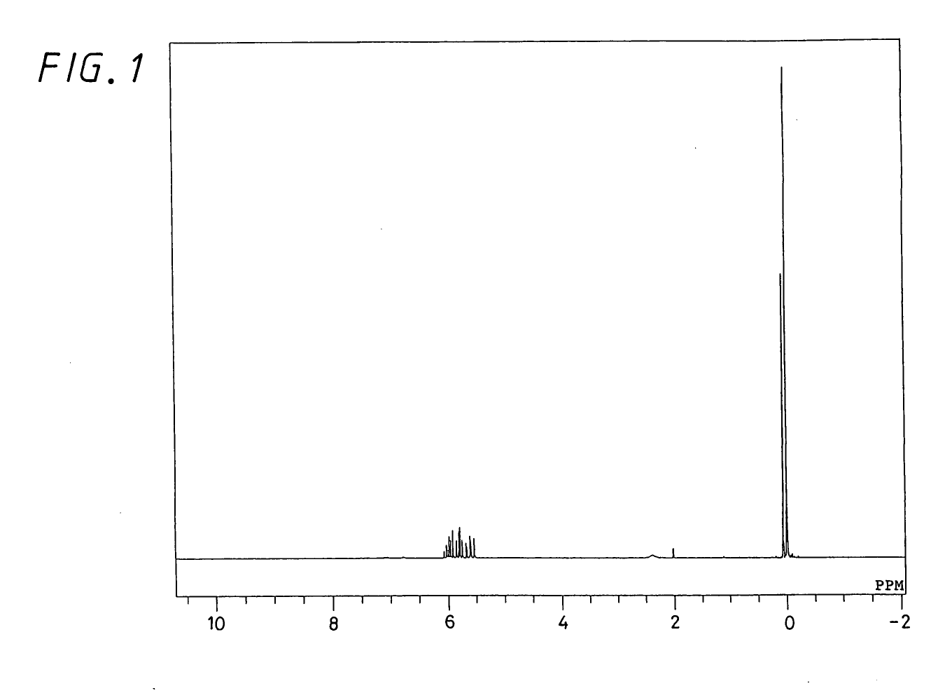

After a two-neck flask of 1 L with a circulation tube was treated by nitrogen substitution, ethyl ether of 700 ml was admitted into the flask in an ice-bath, aniline of 8.38 g (0.09 mol) and water of 1.48 g (0.087 mol) were added thereto and stirred. Vinyl dimethyl chloro silane of 10 g (0.082 mol) that has been dissolved into ethyl ether in advance was slowly dropped and stirred at room temperature for 15 minutes. A reaction was expressed as shown in a chemical formula 9. After a resultant salt was removed by filtration, a product was dehydrated by magnesium sulfate anhydride and a solvent was removed under reduced pressure, thereby resulting in a target compound being obtained. A yield was 63%. An NMR spectrum is shown in FIG. 1.

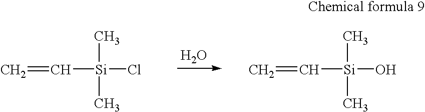

### REFERENCE EXAMPLE 2

Synthesis of bis(dimethyl vinyl siloxy)methyl silane

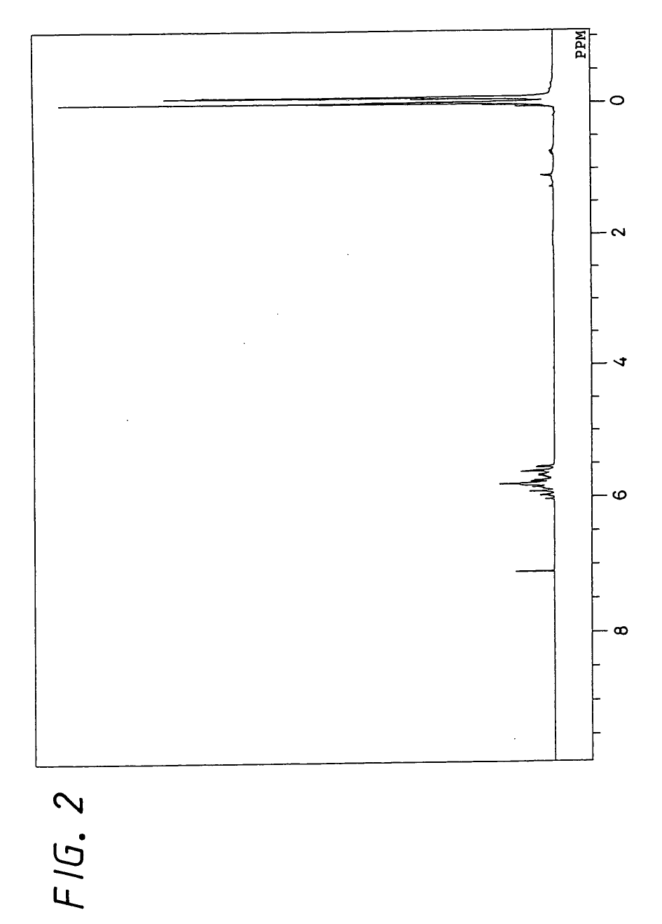

After a two-neck flask of 1 L with a circulation tube was treated by nitrogen substitution, ethyl ether of 500 ml and triethyl amine of 8.21 g (0.081 mol) were admitted into the flask in an ice-bath, dimethyl vinyl silanol of 7.54 g (0.074 mol) was added thereto and stirred. Dichloro methyl silane of 4.24 g (0.037 mol) dissolved into ethyl ether of 50 mol was slowly dropped and stirred at room temperature for 20 minutes. A reaction was expressed as shown in a chemical formula 10. After a resultant salt was removed by filtration, a low-boiling point solvent and the like were removed by an evaporator. Through distillation, there was obtained colorless and transparent bis (dimethyl vinyl siloxy)methyl silane. A yield was 62%. A boiling point (bp) was in a range of from 46 to 48° C./10 mmHg. An NMR spectrum is shown in FIG. 2.

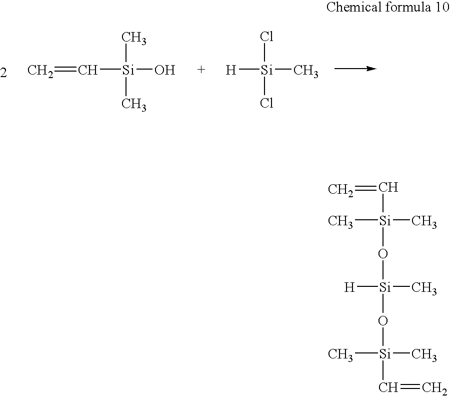

### REFERENCE EXAMPLE 3

Synthesis of Branching (Hyperbranch) Polymer

After a two-neck flask of 100 ml with a circulation tube was treated by nitrogen substitution, bis(dimethyl vinyl soloxy) methyl silane of 2.49 g (0.01 mol) was dissolved into THF of 50 ml in this flask. Several drops of Karstedt solvent (platinum(0)-1,3-diviny-1,1,3,3-tetramethyldisiloxane complex 0.1M in xylene) were added, heated and circumfused until an Si—H group is completely lost in an IR spectrum, whereafter a resultant product was cooled up to room temperature. After a low-boiling point solvent and the like were removed by an evaporator, the product was dropped into acetonitrile and thereby a colorless viscous liquid-like polymer was obtained. A yield was 92%.

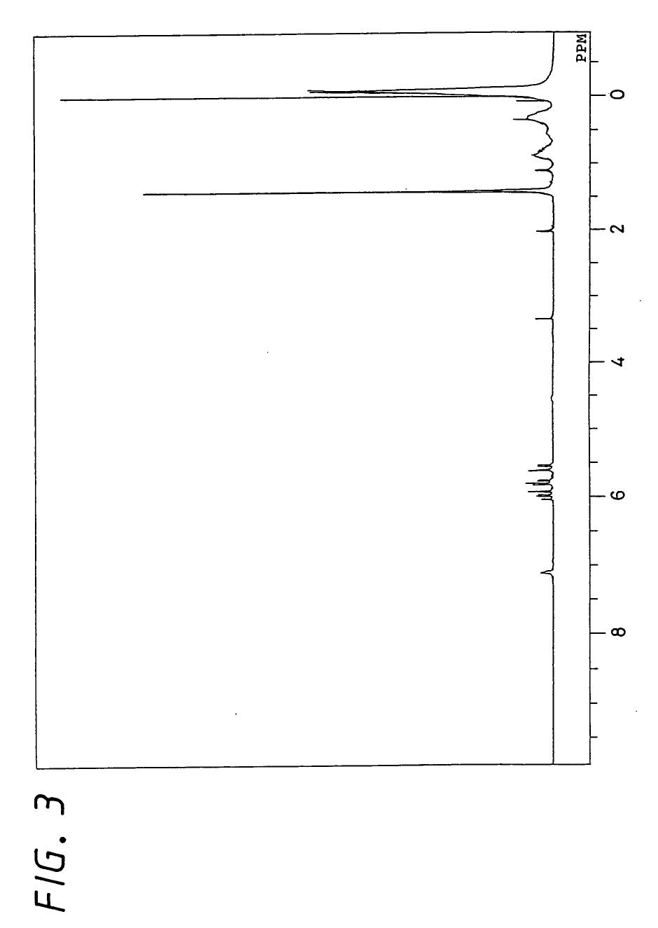

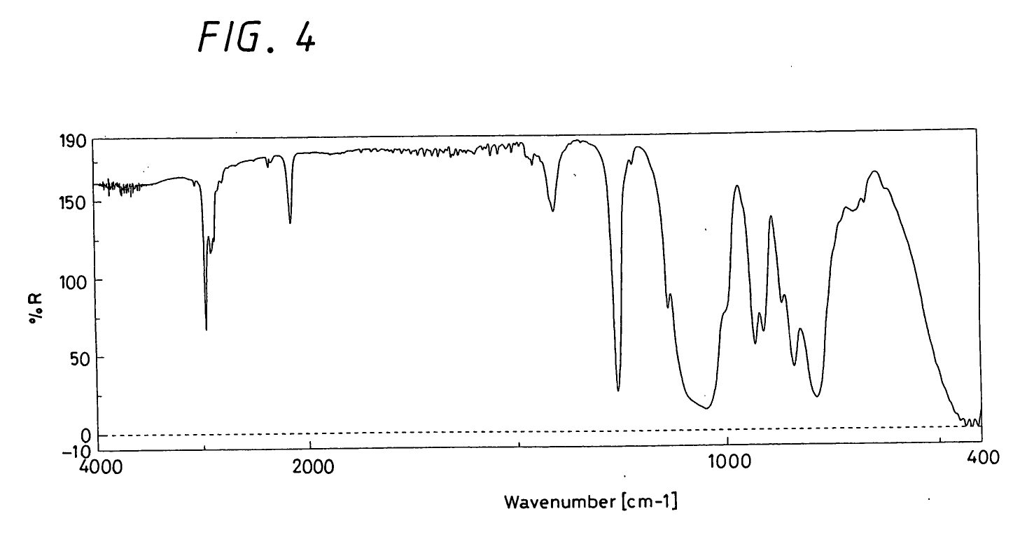

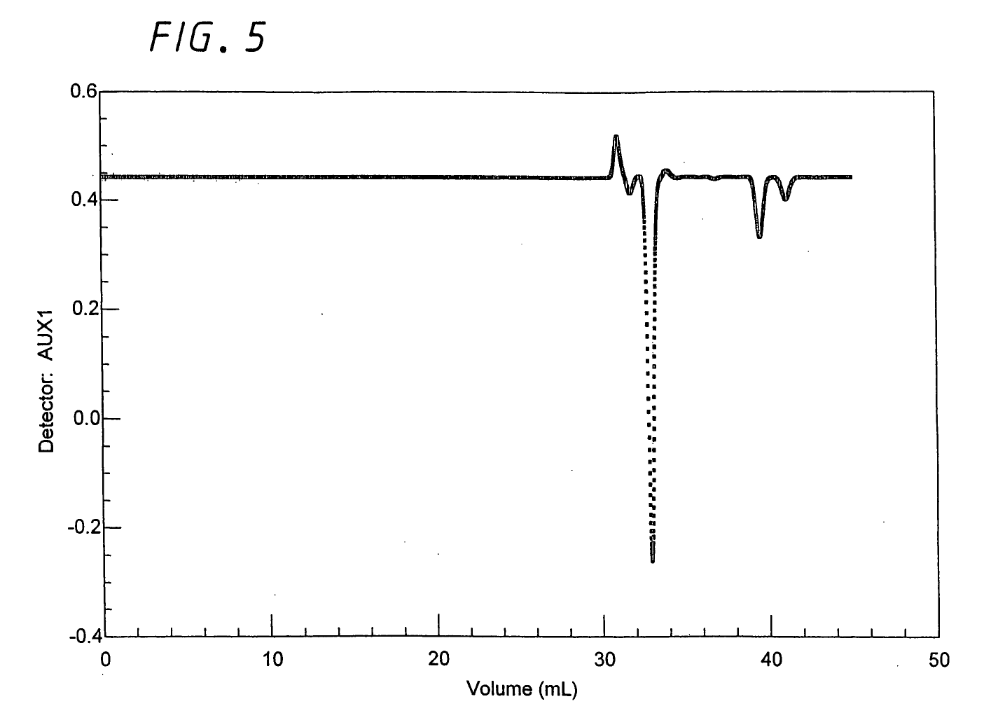

As a result of measuring a GPC molecular weight in which polystyrene is used as a standard and in which a THF is used as a developing solvent, a weight-average molecular weight was 4700. An NMR spectrum is shown in FIG. 3, an infrared absorption spectrum is shown in FIG. 4 and a GPC chart is shown in FIG. 5. It may be considered that a molecular structure of a polymer should be expressed as shown in a chemical formula 11.

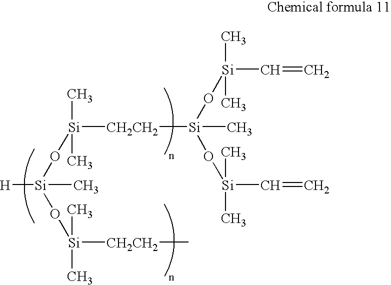

### REFERENCE EXAMPLE 4

Synthesis experiments of the branching (hyperbranch) polymer in the reference example 3 were carried out while a reaction time was changed. Results are shown on the table 1. After the above synthesis experiments were carried out for 72 hours at maximum, a weight-average molecular weight reached 64000.

TABLE 1

| | | Weight-average |
|---|---|---|
| Sample No. | Reaction time (h) | molecular weight |
| 1 | 1 | 1000 |
| 2 | 5 | 3000 |
| 3 | 10 | 9950 |
| 4 | 18 | 20100 |
| 5 | 24 | 32400 |
| 6 | 36 | 52800 |
| 7 | 48 | 61500 |
| 8 | 60 | 63000 |
| 9 | 72 | 64000 |

### INVENTIVE EXAMPLE 1

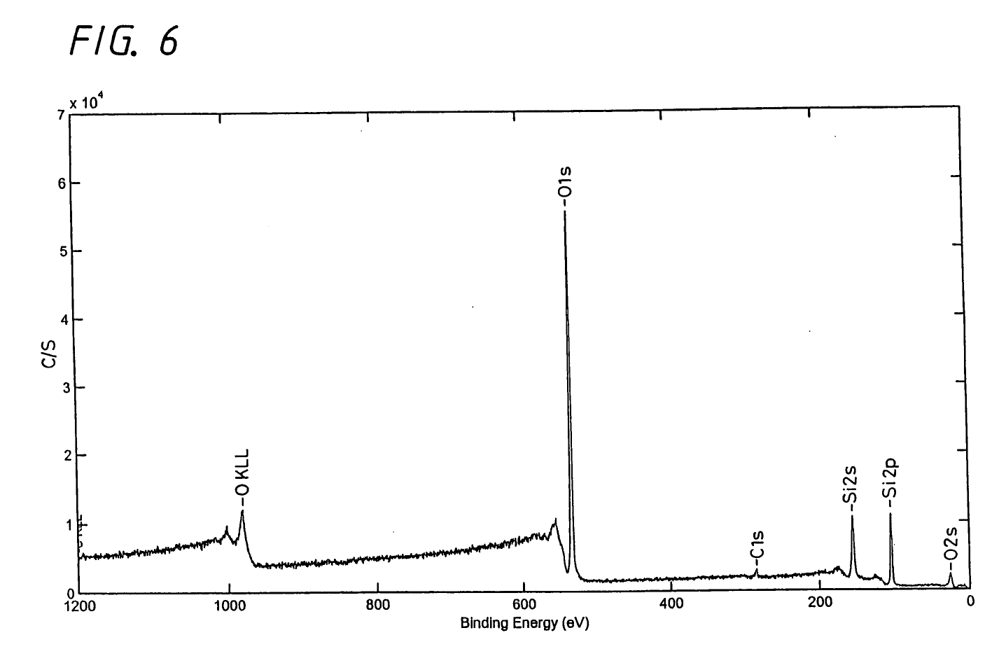

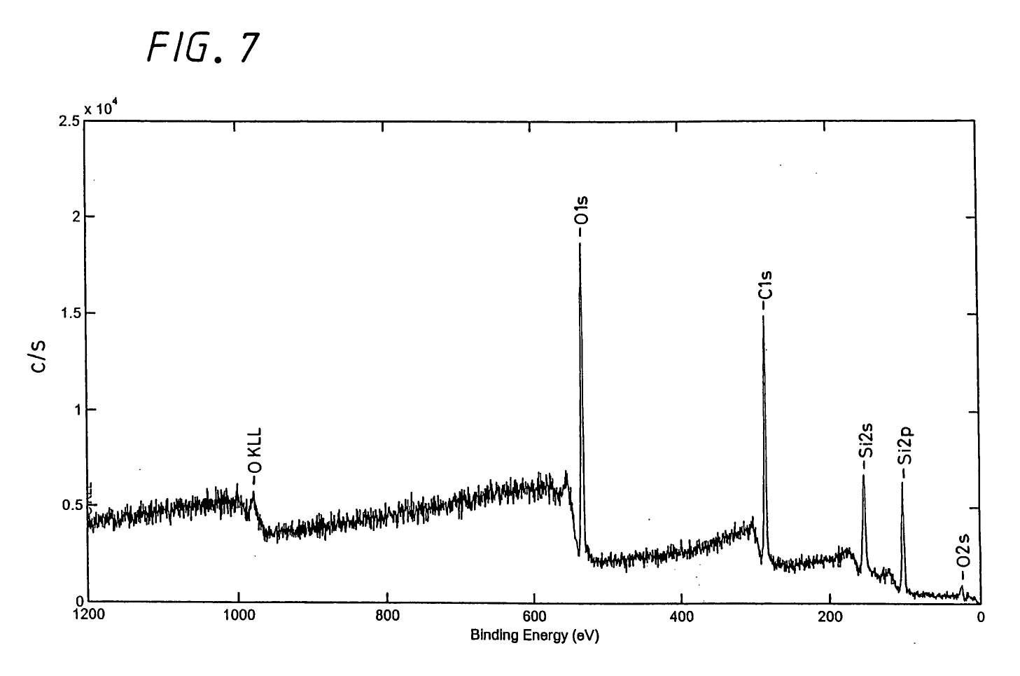

Silica gel particles (average particle diameter 150 μm) for use in column chromatography of 0.1 g and the polymer of 0.1 g of the reference example 3 were mixed and stirred all night long. After silica gel particles had been absorbed and filtered, they were rinsed with hexane and dried in vacuum by an oven at 100° C., thereby resulting in treated silica gel particles being obtained. An XPS spectrum of a used silica gel, which is not yet treated, is shown in FIG. 6 and an XPS spectrum of silica gel particles, which were already treated, is shown in FIG. 7. Since a C1s peak in FIG. 7 becomes large obviously as compared with that of FIG. 6, it is to be understood that the polymer was held on the surface.

### COMPARATIVE EXAMPLE 1

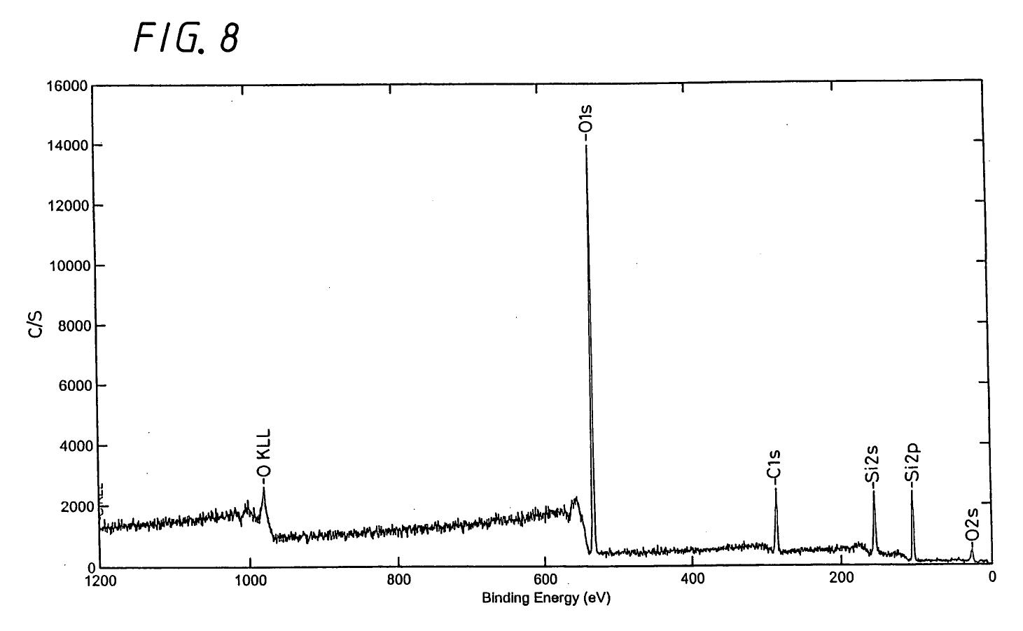

Just same as the inventive example 1, silica gel particles (average particle diameter 150 μm) for use in column chromatography of 0.1 g and the polymer of 0.1 g were mixed and stirred all night long. After silica gel particles had been absorbed and filtered, they were rinsed with hexane and dried in vacuum by an oven at 100° C., thereby resulting in treated silica gel particles being obtained. An XPS spectrum of silica gel particles, which were already treated, is shown in FIG. 8. Since a C1s peak in FIG. 8 becomes large obviously as compared with that of FIG. 6, it is to be understood that the polymer was held on the surface, but it is to be understood that the degree thereof is smaller as compared with the inventive example 1 (FIG. 7).

### INVENTIVE EXAMPLE 2

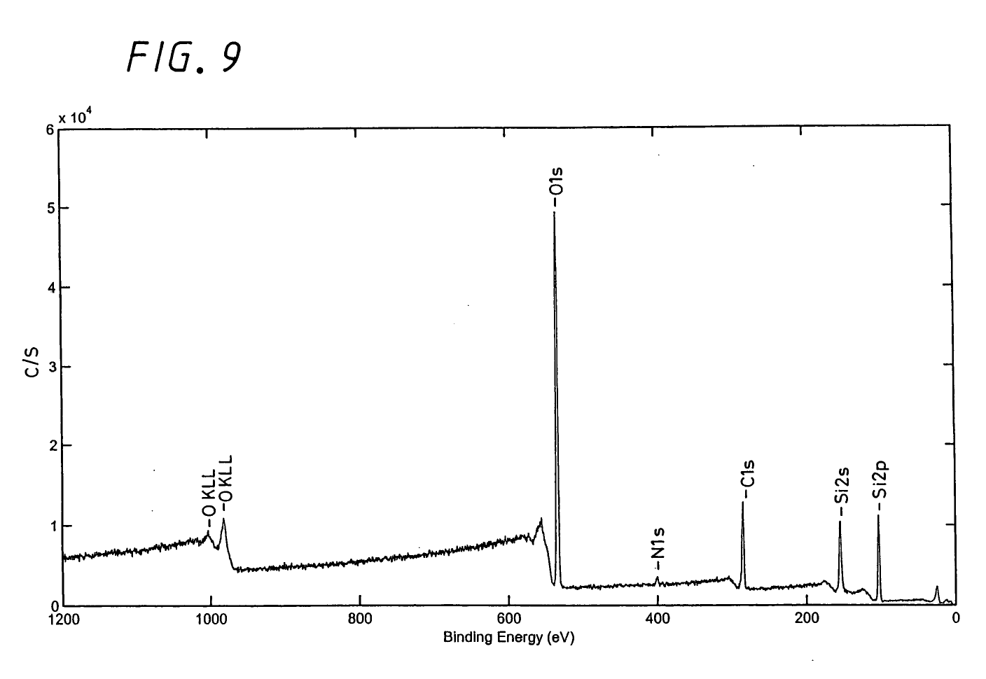

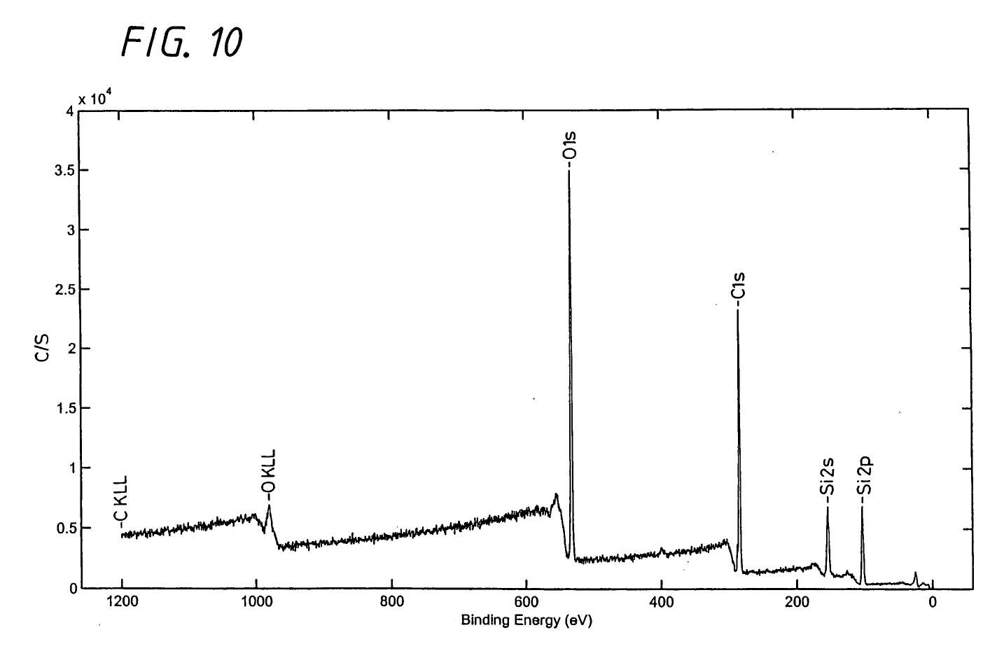

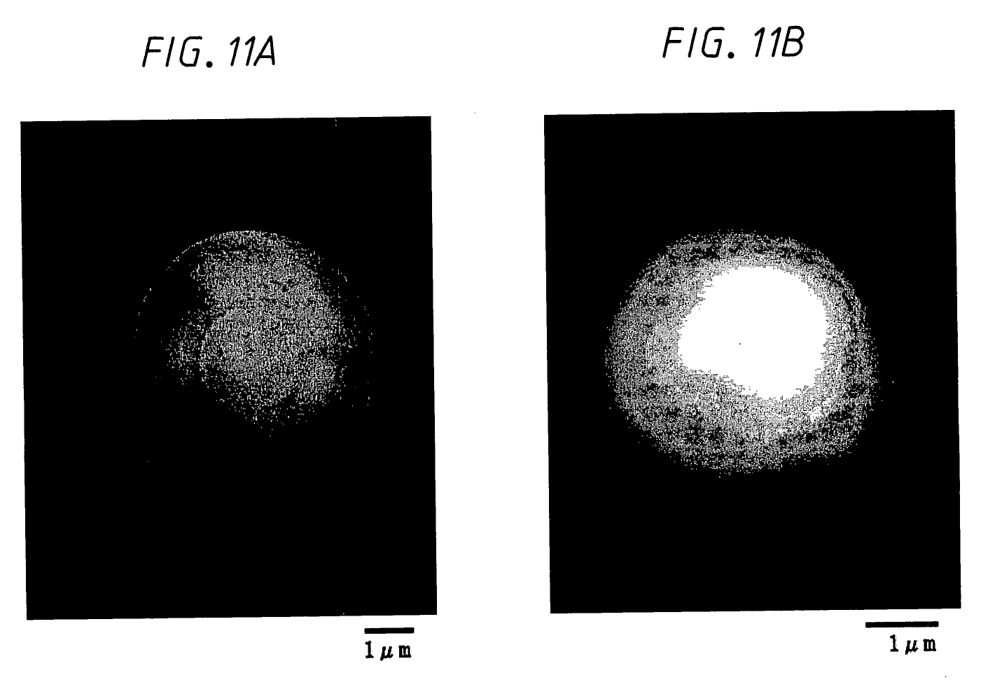

Silica gel particles (average particle size 3 μm) for use in column chromatography of 1.0 g, hexane of 50 ml and the polymer of the reference example 3 of 0.1 g were mixed and stirred all night long. After silica gel particles had been absorbed and filtered, they were rinsed with hexane and dried in vacuum by an oven at 100° C., thereby resulting in treated silica gel particles being obtained. An XPS spectrum of silica gel particles, which are not yet treated, is shown in FIG. 9 and an XPS spectrum of silica gel particles, which were already treated, is shown in FIG. 10. Since a C1s peak in FIG. 10 becomes large obviously as compared with that of FIG. 10, it is to be understood that the polymer was held on the surface. Also, an SEM photograph of silica gel particles, which are not yet treated, is shown in FIG. 11A and an SEM photograph of silica gel particles, which were already treated, is shown in FIG. 11B. Since the particle surface of FIG. 11B becomes smoother as compared with that of FIG. 11A, it is to be understood that the polymer was held on the surface.

### INVENTIVE EXAMPLE 3

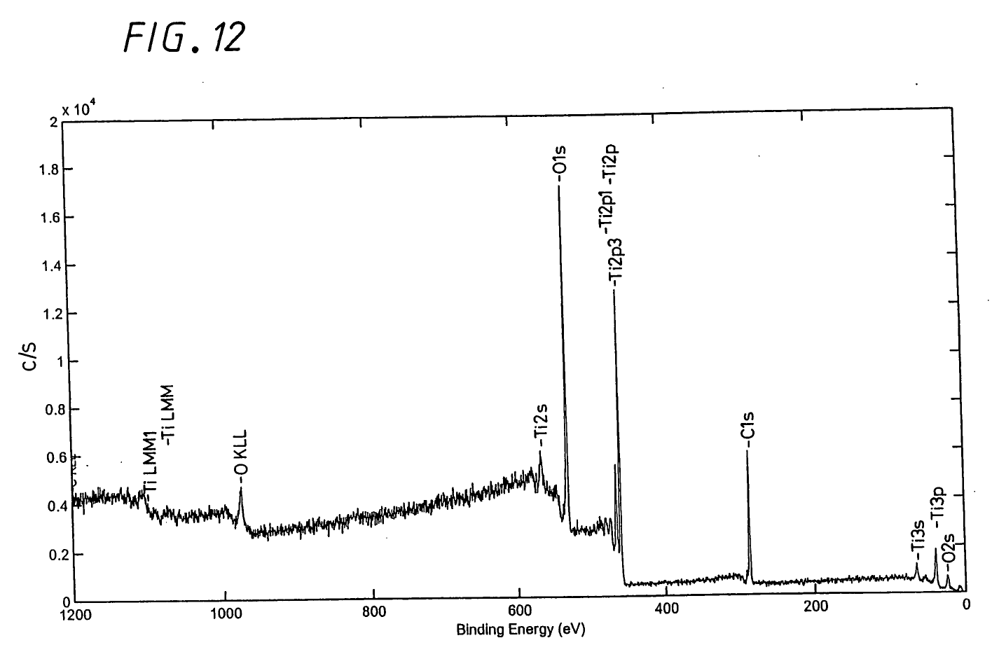

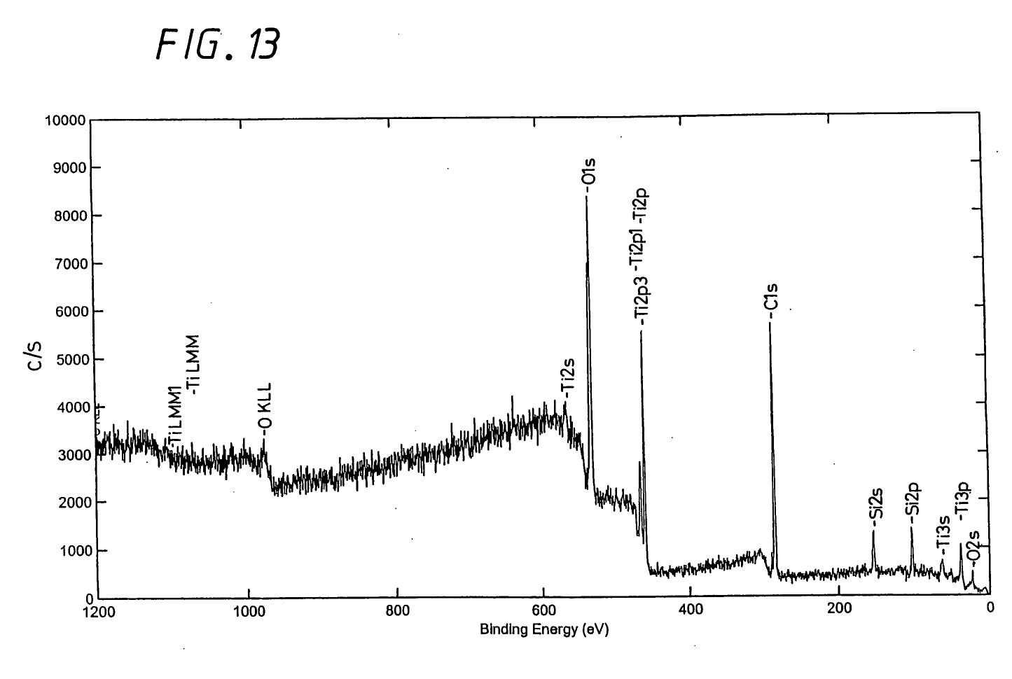

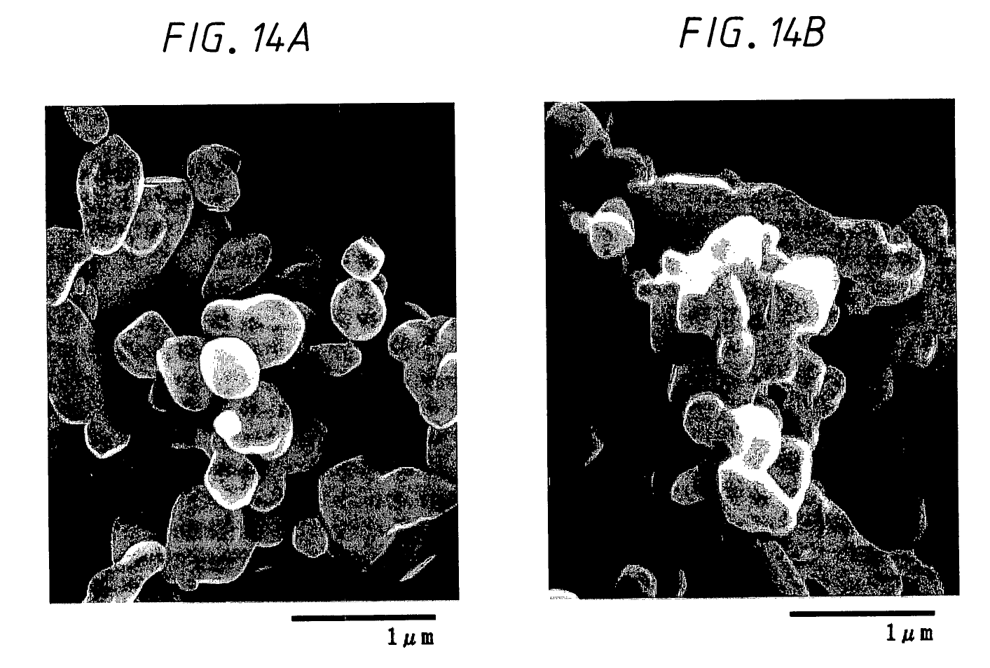

Titanium oxide particles (average particle diameter 1 μm) of 11.0 g, hexane of 50 ml and the polymer of the reference example 3 of 0.1 g were mixed and stirred all night long. After titanium oxide particles had been absorbed and filtered, they were rinsed with hexane and dried in vacuum by an oven at 100° C., thereby resulting in treated titanium oxide particles being obtained. An XPS spectrum of titanium oxide particles, which are not yet treated, is shown in FIG. 12 and an XPS spectrum of titanium oxide particles, which were already treated, is shown in FIG. 13. Since Si2s and Si2p peaks are not visually confirmed in FIG. 12 but they are produced in FIG. 13, it is to be understood that the polymer was held on the surface. An SEM photograph of titanium oxide particles, which are not yet treated, is shown in FIG. 14A and an SEM photograph of titanium oxide particles, which were already treated, is shown in FIG. 14B. Since the particle surface of FIG. 14B becomes smoother as compared with that of FIG. 14A, it is to be understood that the polymer was held on the surface.

### COMPARATIVE EXAMPLE 2

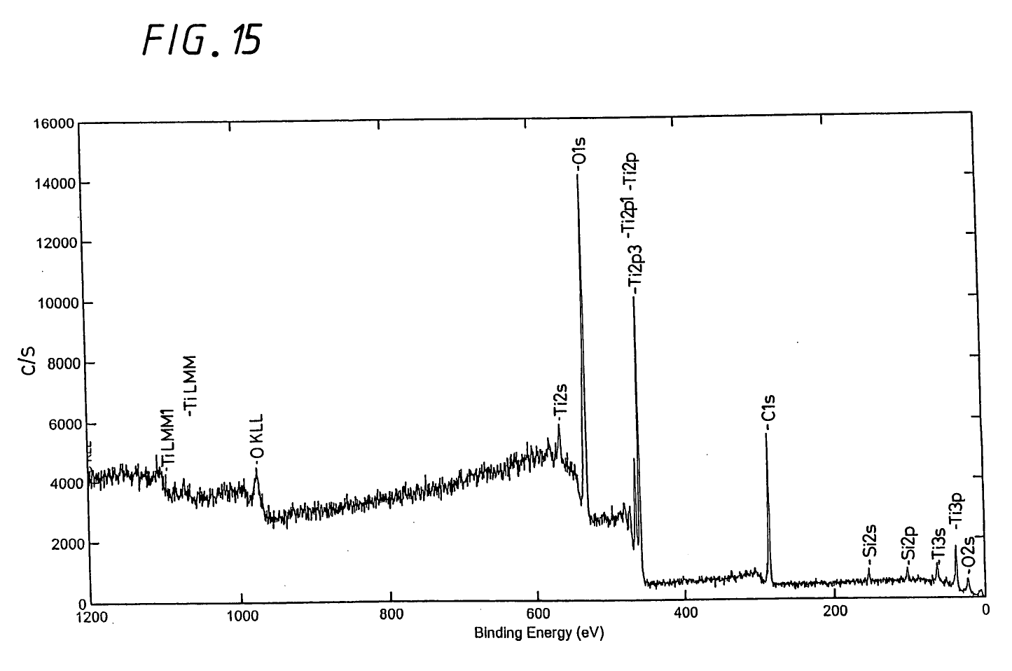

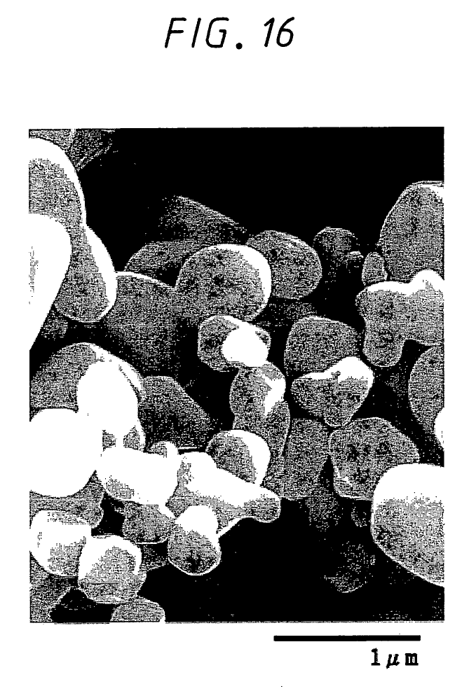

Titanium oxide particles (average particle diameter 1 μm) of 1.0 g, hexane of 50 ml and allyl triethoxy silane of 0.1 g were mixed and stirred all night long. After titanium oxide particles had been absorbed and filtered, they were rinsed with hexane and dried in vacuum by an oven at 100° C., thereby resulting in treated titanium oxide particles being obtained. An XPS spectrum of titanium oxide particles, which were already treated, is shown in FIG. 15. Since Si2s and Si2p peaks are not visually confirmed in FIG. 12 but they are produced in FIG. 15, it is to be understood that allyl triethoxy silane was held on the surface. However, its degree was smaller as compared with that of FIG. 13 of the inventive example 3. An SEM photograph of titanium oxide particles, which were already treated, is shown in FIG. 16. Since the particle surface of FIG. 16 becomes smoother as compared with that of FIG. 14A, it is to be understood that allyl triethoxy silane was held on the surface. However, it is to be understood that its degree is not so large as compared with that of FIG. 14B.

### INVENTIVE EXAMPLE 4

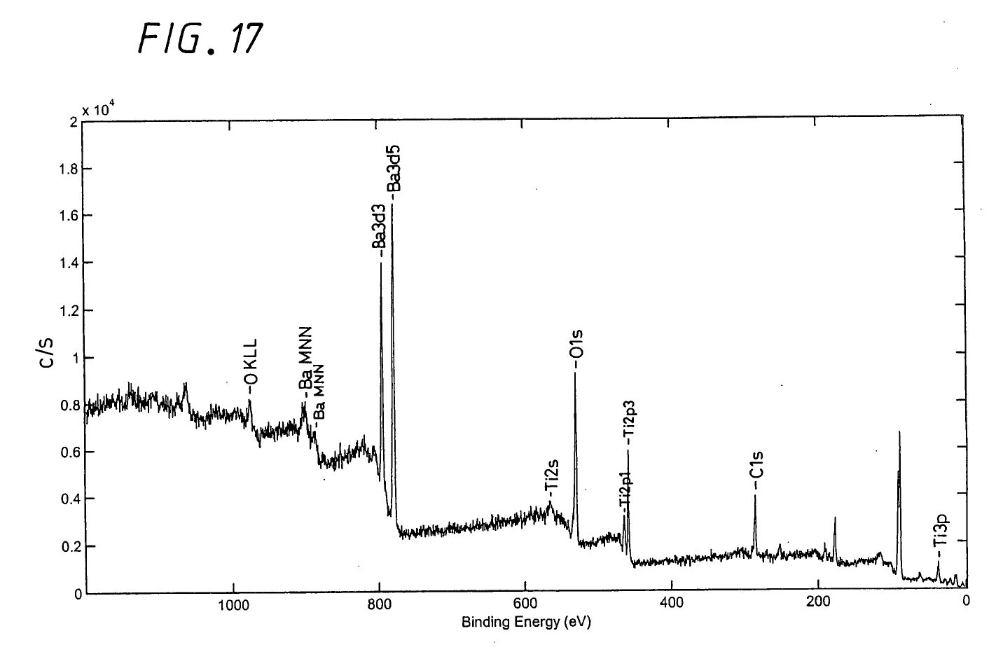

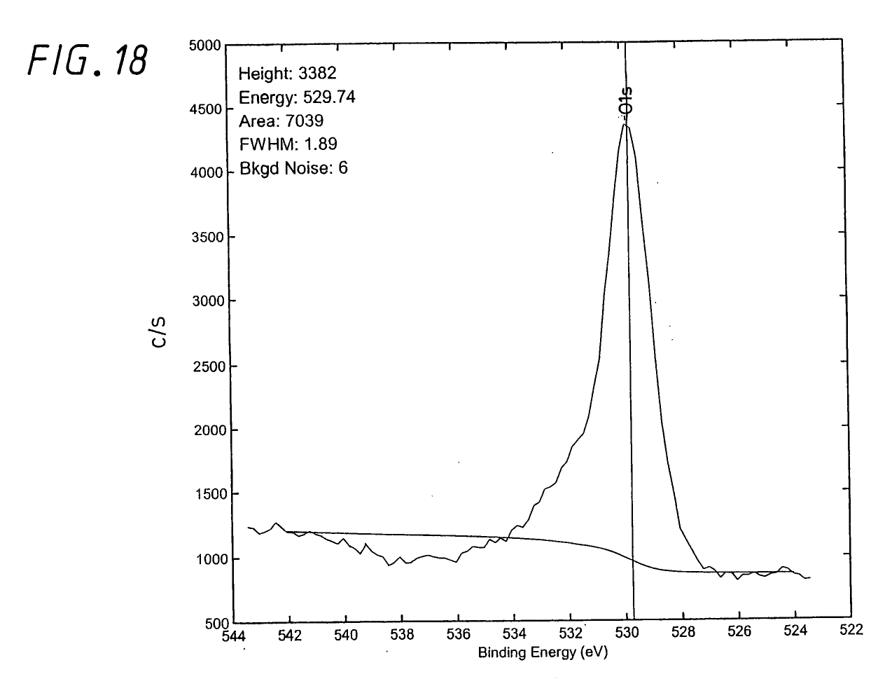

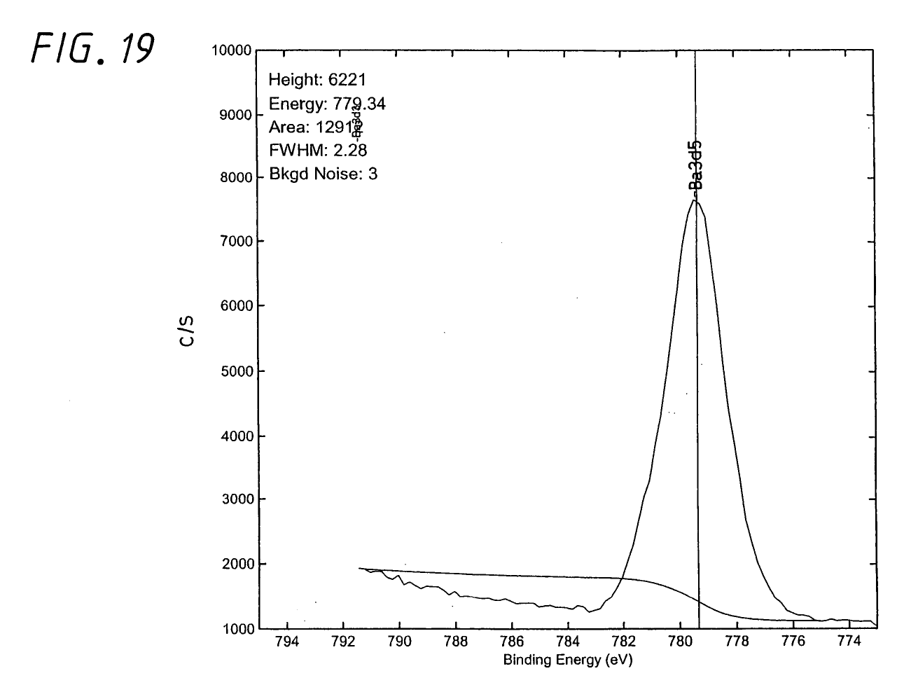

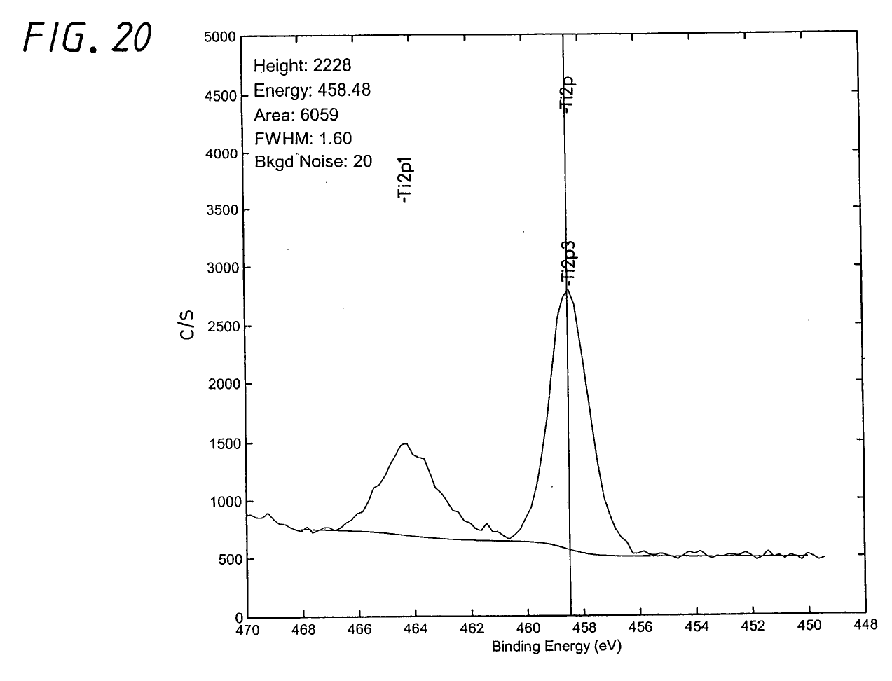

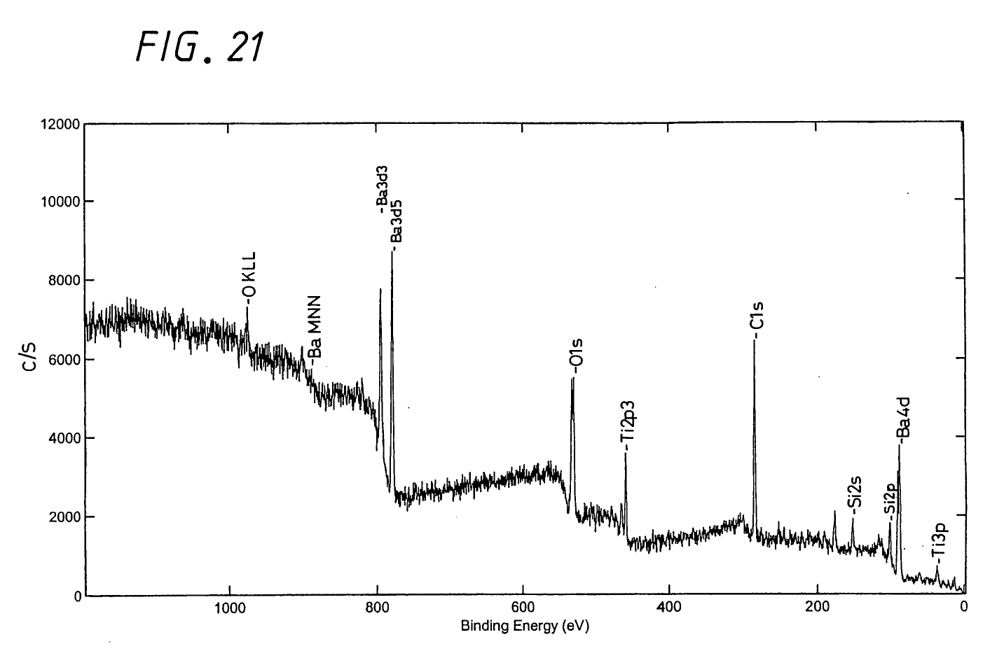

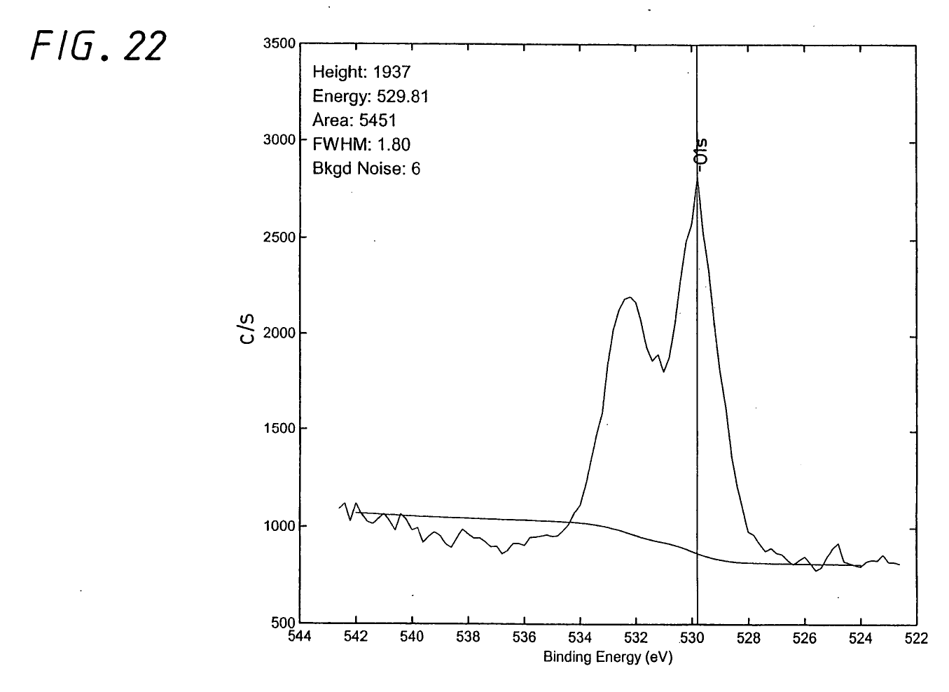

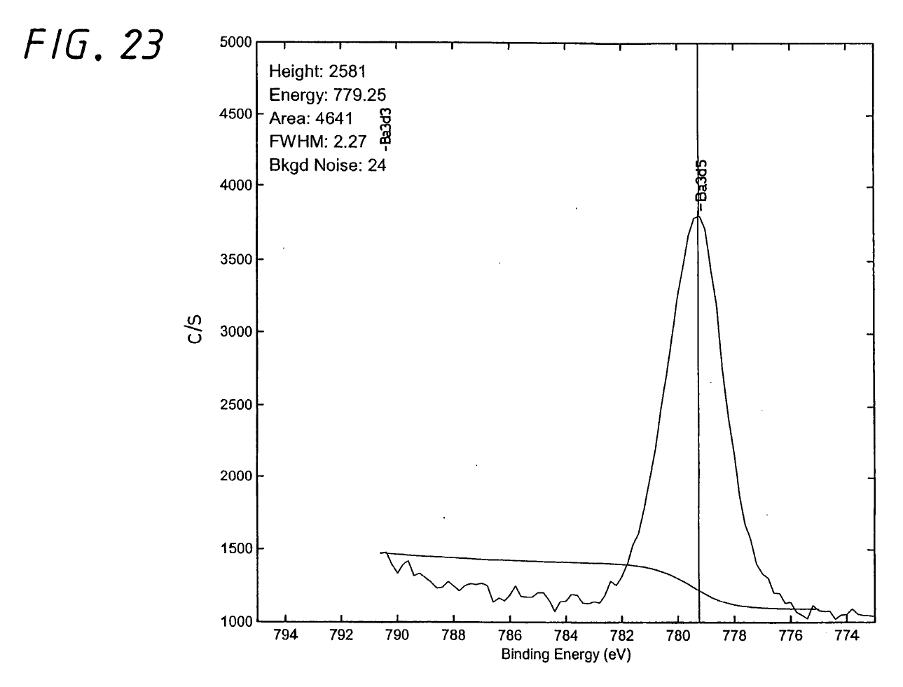

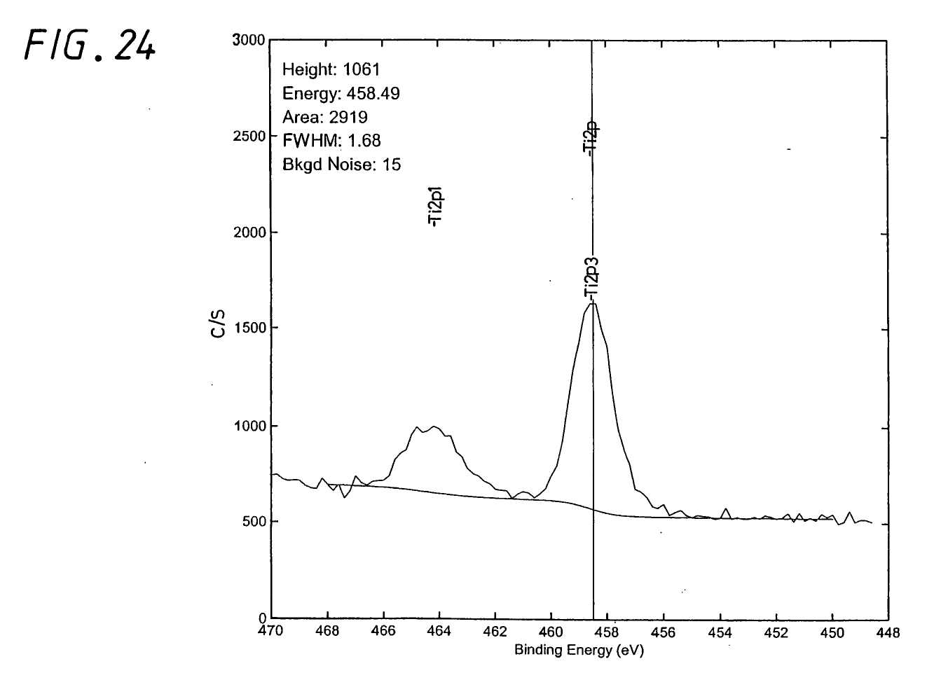

Barium titanate particles (average particle diameter 0.9 μm) of 1.0 g, hexane of 50 ml and the polymer of the reference example 3 of 0.1 g were mixed and stirred all night long. After barium titanate particles had been absorbed and filtered, they were rinsed with hexane and dried in vacuum by an oven at 100° C., thereby resulting in treated barium titanate particles being obtained. XPS spectrums of used barium titanate particles, which are not yet treated, are shown in FIGS. 17 to 20 and XPS spectrums of barium titanate particles, which were already treated, are shown in FIGS. 21 to 24. Since Si2s and Si2p peaks are not visually confirmed in FIG. 17 but they are produced in FIG. 21. Also, in enlarged diagrams (FIGS. 18, 22) of O1s peaks, a new peak originated from siloxane bonding of the polymer of the reference example 3 is observed in FIG. 22. Having compared FIGS. 19 and 23 and FIGS. 20 and 24, peaks of Ba3d and Ti2p are not changed before and after the treatment. From the above, it is to be understood that the polymer was held on the surface.

### INVENTIVE EXAMPLE 5

A branching polymer was synthesized by a method similar to that of the reference example 3 except that bis(dimethyl vinyl siloxy)methyl silane of 0.83 g (sample 1), 3.74 g (samples 2, 3), 4.98 g (samples 4, 5), 0.03 g (sample 6) and 9.96 g (sample 7) were dissolved into THF of 50 ml. Molecular weights of the thus obtained respective polymers are shown on the table 2. Polymers were coated on the surface of titanium oxide of particle diameter of 1 μm by a method similar to that of the inventive example 3 except that these polymers are used and that 0.1 g (samples 1, 2, 4, 6, 7) and 0.2 g (samples 3, 5) were mixed into hexane of 50 ml. Coated quantities of polymers coated on the surfaces of treated titanium oxide particles are shown on the table 2. In the method of measuring the polymer coated quantities, weights of titanium oxide particles obtained before and after treatment were measured and calculated.

Functions of the thus obtained treated titanium oxide particles were evaluated by the following method. First, treated titanium oxide particles of 0.5 g were mixed into methyl ethyl ketone of 10 ml and stirred strongly for 5 minutes. Thereafter, its mixed solution was left still for 2 hours. Obtained results are shown on the table 2. It was confirmed that the treated titanium oxide particles are almost not precipitated in the samples 1 to 5. It was confirmed that the samples 6, 7 have much sedimentations. The reason that the treated titanium oxide particles are almost not precipitated in the samples 1 to 5 may be considered such that the surface of the titanium oxide particle was coated with a branching siloxane which has high affinity with methyl ethyl ketone.

TABLE 2

| | | | Dispersion |
|---|---|---|---|
| | | Polymer coated | stability |
| | Weight-average | quantity | (dispersion |
| | molecular | (g/titanium | stability |
| Sample | weight | oxide | obtained 2 hours |
| No. | of polymer | particles 1 g) | later) |
| 1 | 1200 | 0.008 | Good |
| 2 | 9800 | 0.059 | Good |
| 3 | 9800 | 0.089 | Good |
| 4 | 23500 | 0.12 | Good |
| 5 | 23500 | 0.186 | Good |
| 6 | 700 | 0.002 | Unsatisfactory |
| | | | (much sediment) |
| 7 | 100000 | 0.362 | Unsatisfactory |
| | | | (much sediment) |

### INVENTIVE EXAMPLE 6

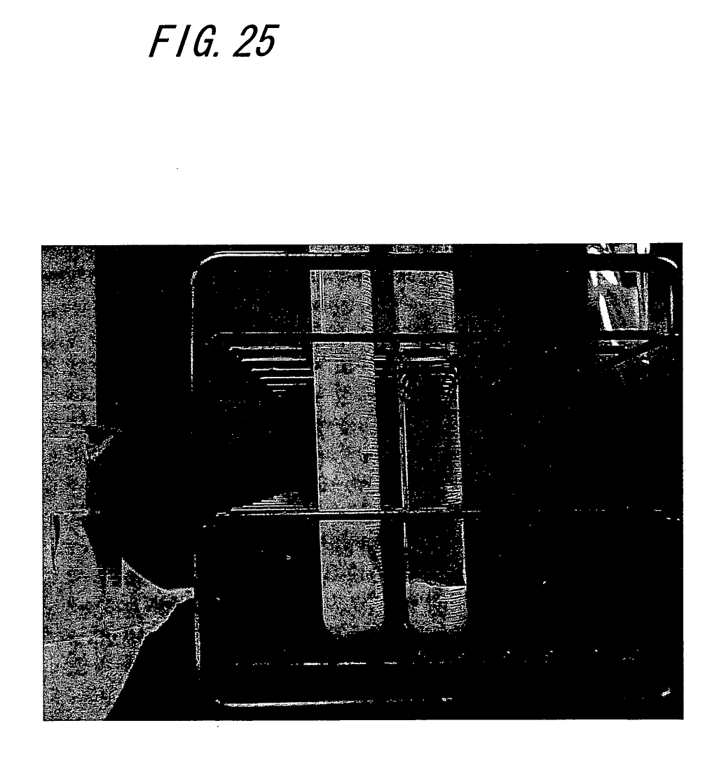

Barium titanate particles of 1 g were admitted into a test tube and barium titanate particles added with methyl ethyl ketone of 17 ml were admitted into another test tube. The hyper branch poly siloxane of 0.1 g of the reference example 3 was added to one text tube. FIG. 25 shows a photograph obtained after 24 hours since the two test tubes have been strongly stirred for 5 minutes. Although barium titanate particles are not precipitated in the left test tube in which the hyper branch poly siloxane was added, barium titanate particles were completely precipitated in the right test tube in which the hyper branch poly siloxane was not added. From the above, it is to be understood that the hyper branch poly siloxane has a high capability to disperse inorganic metal oxide particles.

### INVENTIVE EXAMPLE 7

Study of adhesion of hyper branch poly siloxane with glass surface

After glass substrates, which were rinsed with a rinsing solution and pure water in advance, had been immersed into a saturated potassium hydroxide ethanol solution for 2 hours and rinsed three times with pure water by using a ultrasonic cleaning machine, they were air-dried within a clean bench. After the glass substrates, which were treated with hydrophilicity, have been immersed into a hexane solution of the hyper branch poly siloxane of the reference example 3 and sequentially rinsed with a large amount of hexane and acetone, they were air-dried within the clean bench. Static contact angles were measured by using pure water. Further, the treatments of the samples 5, 6, 7 shown on the table 3 were carried out and static contact angles were measured. Results are shown on the table 3. As is clear from the table, it is to be understood that the hyper branch polymer strongly adhered to the glass surface.

TABLE 3

| | | Contact |
|---|---|---|
| Sample | | angle |
| No. | Sample | (°) |
| 1 | Hydrophilic glass substrate | 7 |
| | which was not yet Treated | |
| 2 | Polymer solution of one mass % | 54 |
| | (surface finishing time is 2 hours) | |
| 3 | Polymer solution of 4 mass % | 56 |
| | (surface finishing time is 10 minutes) | |
| 4 | Polymer solution of 4 mass % | 56 |
| | (surface finishing time is 2 hours) | |
| 5 | Sample 4 was left in the air | 56 |
| | at room temperature for a week | |
| 6 | Sample 4 was heated in the air | 56 |
| | at 100° C. for 12 hours | |
| 7 | Sample 4 was heated in the toluene | 54 |
| | at 60° C. for 15 hours | |

1. A polymer coated metal oxide characterized in that a polymer has a siloxane skeletal structure.

2. A polymer coated metal oxide according to claim 1, characterized in that a polymer has a branching structure.

3. A polymer coated metal oxide according to claim 2, characterized in that a polymer having a branching structure is a dendritic polymer.

4. A polymer coated metal oxide according to claim 2, characterized in that a polymer having a branching structure is strongly bonded to a metal oxide to be coated.

5. A polymer coated metal oxide according to claim 1, characterized in that a polymer is a polymerized product obtained by mixing singles of or more than two kinds of bis (dimethyl vinyl siloxy)methyl silane, tris(dimethyl vinyl siloxy) silane and bis(dimethyl allyl siloxy)methyl silane and tris(dimethyl allyl siloxane) silane or by mixing singles of or more than two kinds of bis(dimethyl siloxy)methyl vinyl silane, tris(dimethyl siloxy)vinyl silane, bis(dimethyl siloxy)methyl allyl silane and tris(dimethyl siloxy) allyl silane.

6. A polymer coated metal oxide according to claim 5, characterized in that a molecular weight of a polymer falls within a range of 1000 to 80000.

7. A polymer coated metal oxide according to claim 1, characterized in that a metal oxide is a product obtained by combining singles of or more than two kinds of glass, silica gel, titanium oxide, barium titanate, indium tin oxide (ITO), aluminum oxide, nickel oxide and iron oxide.

8. A polymer coated metal oxide according to claim 1, characterized in that a metal oxide is obtained by combining singles of or more than two kinds of grain-like, thread-like and plate-like metal oxides.

9. A polymer coated metal oxide according to claim 7, characterized in that a coated quantity of a polymer falls within a range of from 0.005 to 0.2 g per 1 g of a metal oxide.

10. A polymer coated metal oxide manufacturing method characterized in that a metal oxide is brought in contact with a solution of a polymer having a siloxy skeletal structure.

11. A polymer coated metal oxide manufacturing method according to claim 11, characterized in that a polymer has a branching structure.

12. A polymer coated metal oxide manufacturing method according to claim 11, characterized in that a polymer having a branching structure is a dendritic polymer.

13. A polymer coated metal oxide manufacturing method according to claim 10, characterized in that a polymer is a polymerized product obtained by mixing singles of or more than two kinds of bis(dimethyl vinyl siloxy)methyl silane, tris(dimethyl vinyl siloxy) silane and bis(dimethyl allyl siloxy)methyl silane and tris(dimethyl allyl siloxane) silane or by mixing singles of or more than two kinds of bis(dimethyl siloxy)methyl vinyl silane, tris(dimethyl siloxy)vinyl silane, bis(dimethyl siloxy)methyl allyl silane and tris(dimethyl siloxy) allyl silane.

14. A polymer coated metal oxide manufacturing method according to claim 13, characterized in that a molecular weight of a polymer falls within a range of 1000 to 80000.

15. A polymer coated metal oxide manufacturing method according to claim 10, characterized in that a metal oxide is a product obtained by combining singles of or more than two kinds of glass, silica gel, titanium oxide, barium titanate, indium tin oxide (ITO), aluminum oxide, nickel oxide and iron oxide.

16. A polymer coated metal oxide manufacturing method according to claim 10, characterized in that a metal oxide is obtained by combining singles of or more than two kinds of grain-like, thread-like and plate-like metal oxides.

17. A polymer coated metal oxide manufacturing method according to claim 15, characterized in that a coated quantity of a polymer falls within a range of from 0.005 to 0.2 g per 1 g of a metal oxide.
